(19) United States
(12) Patent Application Publication
(10) Pub. No.: US 2010/0268655 A1
(43) Pub. Date: Oct. 21, 2010

(54) Social Capital

(76) Inventor: Joel Cheuoua, Mountain View, CA (US)

Correspondence Address: Joel Cheuoua, Apt # 331, 541 Del Medio Avenue, Mountain View, CA, 94040, US

(21) Appl. No.: 12/424,361

(22) Filed: Apr. 15, 2009

(51) Int. Cl. G06Q 99/00

(52) U.S. Cl. 705/319

(57) ABSTRACT

Systems and methods for receiving social network membership information from a user, receiving social networking information for the user, and determining a social capital for the user, wherein the social capital is at least partially based on the social network membership information and the social networking information.

### FIELD

Embodiments of the present invention relate in general to the field of social networking.

### BACKGROUND

Some social networks bring people together through interest groups to share stories, activities, and hobbies or to get things done thanks to the size and diversity of talents. For example, if one user posts an interest and information regarding a particular hobby on a social network site, other users may view and contribute to the particular hobby. If one user posts pictures or personal information on his profile, other users may interact with the posts by viewing, commenting, and the like. A social life affect of interactions of the user and the other users may not be clear to the user or the other users. Also, the user who shares the information unknowingly how relevant, useful and safe the nature of posts. What is needed is a way to provide feedback for social interactions.

### SUMMARY

Systems and methods implementing social capital are discussed herein. The method comprises receiving social network membership information from a user, receiving social networking information for the user, and determining a social capital for the user, wherein the social capital is at least partially based on the social network membership information and the social networking information.

### BRIEF DESCRIPTION OF THE DRAWINGS

The accompanying drawings, which are incorporated in and form a part of this specification, illustrate embodiments of the presented technology and, together with the description, serve to explain the principles of the presented technology:

FIG. 1 illustrates a community of users with social capital at a network level, in accordance with embodiments.

FIG. 2 illustrates a server for social capital implementation, in accordance with embodiments.

FIG. 3 illustrates a community of users with social capital at a user level, in accordance with embodiments.

FIG. 4 is a flow chart of a method for social capital implementation, in accordance with embodiments.

FIG. 5 illustrates a server, in accordance with embodiments.

### DESCRIPTION OF EMBODIMENTS

Reference will now be made in detail to various embodiments of the present invention, examples of which are illustrated in the accompanying drawings. While the present invention will be described in conjunction with the various embodiments, it will be understood that they are not intended to limit the invention to these embodiments. On the contrary, embodiments of the present invention are intended to cover alternatives, modifications and equivalents, which may be included within the spirit and scope of the appended claims. Furthermore, in the following description of various embodiments of the present invention, numerous specific details are set forth in order to provide a thorough understanding of embodiments of the present invention. In other instances, well known methods, procedures, components, and circuits have not been described in detail as not to unnecessarily obscure aspects of the embodiments of the present invention.

In the following description, numerous specific details are set forth to provide a thorough understanding. However, it will be recognized by one of ordinary skill in the art that embodiments may be practiced without these specific details. In other instances, well known methods, procedures, and components have not been described in detail as not to unnecessarily obscure aspects of the present invention.

In various embodiments of the present invention, a method for using social capital is discussed. The method comprises receiving social network membership information from a user, receiving social networking information for the user, and using the social network membership information and the social networking information, determining a social capital for the user.

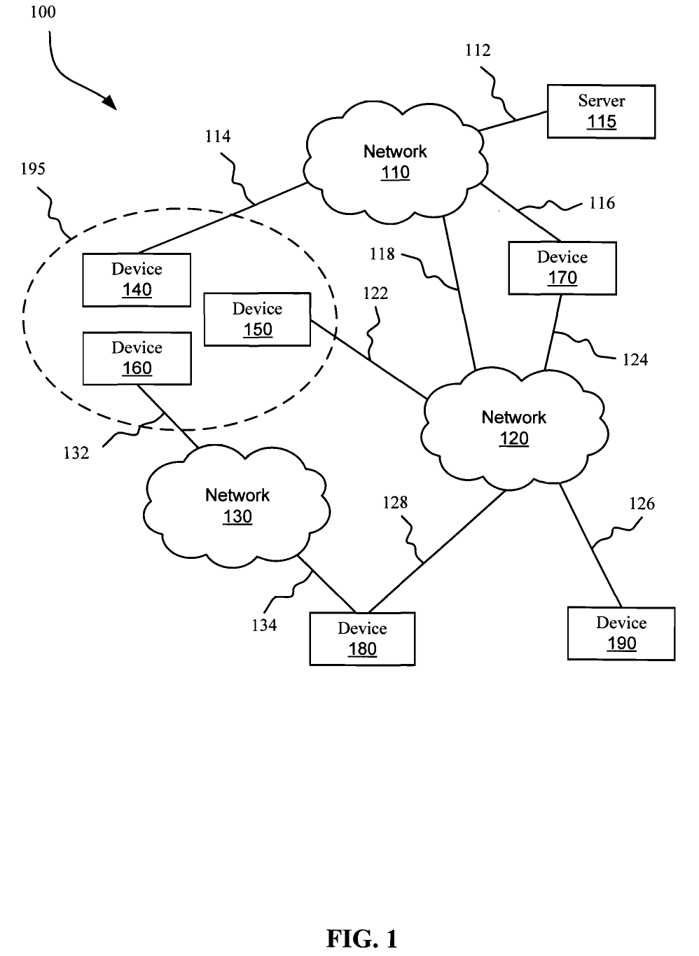

FIG. 1 illustrates a community 100 of users with social capital at a network level, in accordance with embodiments. The community 100 comprises one or more networks, such as a network 110, a network 120, and a network 130, one or more devices, such as a device 140, a device 150, a device 160, a device 170, a device 180, and a device 190, and a server 115.

A network may be a telecommunication network, a computer network, such as the Internet, or any network that a user of a device may communicate via a communication path. The device may be any device that may communicate with a network, such as a computer, a mobile phone, a personal data assistant, a global positioning device, and the like. The communication path is any medium that allows communication between a device and a network, such as land-line, wireless, and the like.

The network 110 is configured to communicate information with the one or more devices, such as device 140 via a communication path 114, device 170 via a communication path 116, to communicate information with a network, such as network 120 via communication path 118, and to communicate with a server, such as server 115 via communication path 112. In some embodiments, networks 120 and 130 are similar to network 110, in that the networks communicate with devices, such as network 120 communicates with device 170 via communication path 124, and communicate the server 115. In one embodiment, a device communicates with more than one network and/or server, such as device 180 communicating with network 120 via communication path 128 and with network 130 via communication path 134.

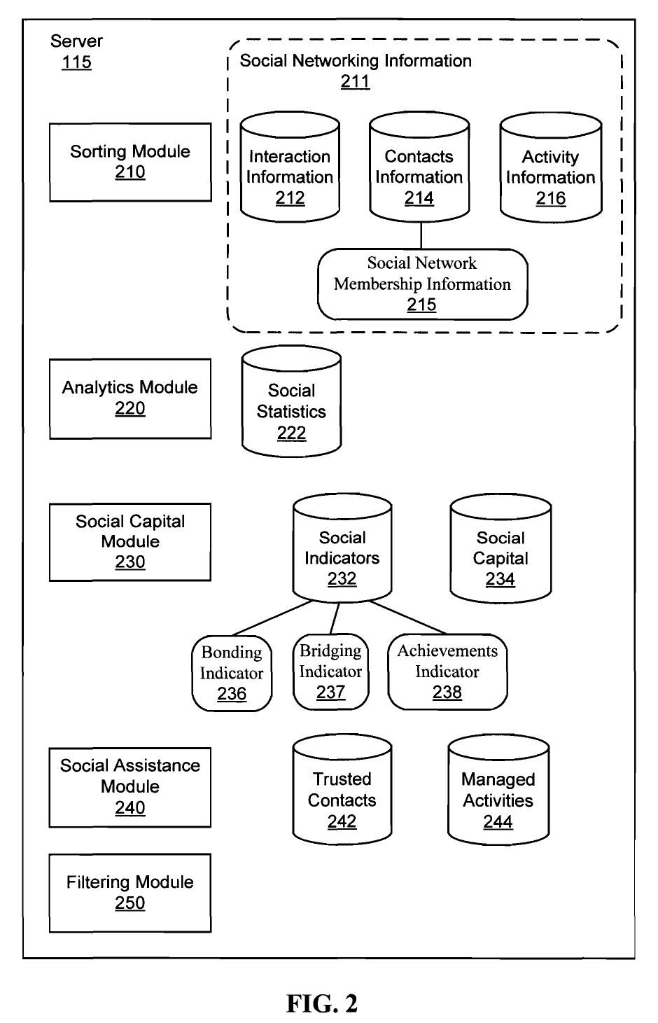

The server 115 may be one or more computers that communicate via networks and communications paths with devices, such as device 140. The server 115 is configured to administrate social capital. The server 115 is discussed further herein and with regard to FIG. 2. Social capital as further discussed herein and with regard to FIGS. 2, 3, and 4.

The device 140 may be operated by a user who also operates other devices, such as device 150 and device 160, as indicated by a dotted line 195. In some embodiments, devices used by a user are different kinds of devices, such as a mobile phone, a personal digital assistant, a computer, a two-way radio, or any other device that may communicate via a network. In other embodiments, only one device is used to communicate, such as a computer, a mobile phone, or the like.

FIG. 2 illustrates a server 115 for social capital implementation, in accordance with embodiments. The server 115 comprises social networking information 211 (hereinafter referred to as information), modules, social statistics 222, social indicators 232, social capital 234, trusted contacts 242, and managed activities 244. The social networking information 211 may pertain to social network information, such as, interaction information 212, contacts information 214, and activity information 216. In one embodiment, the modules comprise modules for using, analyzing, storing and filtering the information, such as a sorting module 210, an analytics module 220, a social capital module 230, a social assistance module 240, and a filtering module 250. In other embodiments, modules are used to send, parse, receive and/or other like functions to ascertain and/or modify social capital.

The information may originate from transactions associated with a social network, an email network and/or server, an event planning network, a dating network, a blogging network, other collaboration network sites, contributors, members, users, and the like. Some examples of social networks are Facebook, LinedIn, MySpace, Twitter, and the like. Some examples of an email networks and/or mail servers are Gmail, Hotmail, Yahoo Mail, corporate mail servers, instant messaging servers, phone servers, and the like. Some examples of event planning networks are Evite.com, Meetup.com, Socializr.com, and the like. Some examples of dating networks are Match.com, eHammony.com, and the like. Some examples of blogging networks are Blog/Vlog sites, Youtube, Blogger, Digg, and the like. Some examples of other collaboration network sites are Huddles, Fundable.com, The Point.com, Wikipedia, and the like. Some examples of instant messaging servers are IM, AIM, Messenger, and the like. Some examples of phone servers are Skype, and the like. Information provided by a user may be personalized by the user, that is, the user may make comments, add notes, change content, and the like, thereby the information may be tailored, which may provide for a richer, dynamic, and more accurate portrayal of the information.

The sorting module 210 receives the information from the network sources, parses the information, analyses the information for content, and associates the information with another module. In one embodiment, the information may be received directly from the network source. In another embodiment, the information is input by a user. In still another embodiment, the information is received from a third party, such as another user, an association affiliated with a network, a selected user, and the like. Selected users are selected by the user and further discussed herein.

In one embodiment, the sorting module 210 associates the information with one or more different types of information, such as the interaction information 212, the contacts information 214, and/or the activity information 216. For example, information regarding two people getting together is associated with interaction information 212. In another example, information regarding individuals is associated with contacts information 214. In yet another example, information regarding an event is associated with activity information 216. In another embodiment, the sorting module 210 associates the information with one or more different modules. For example, the contacts information 214 is associated with the filtering module 250, with the social assistance module 240, and/or with the analytics module 220.

The sorting module 210 may parse information. Parsing is performed to remove and/or refine the information. In one embodiment, parsing and/or refining are performed on information and the information is associated with two or more types, such as contacts information 214 and activity information 216.

Interaction information 212 is information regarding interactions and is associated with interactions between one or more user. Interactions may be the aggregation of casual communications with a contact. For example, an interaction is a phone call, an email, an instant message (“IM”), a poke on Facebook, a reply to a tweet on Tweeter, a conversation at a bar, and the like. In one embodiment, the sorting module 210 automatically tracks and collects the interaction. In another embodiment, the sorting module 210 receives the interaction information 212 manually. For example, a user supplies information to the sorting module 210 regarding a conversation at the bar. In one embodiment, interaction information 212 includes an entire conversation, for example, a textual and/or recorded dialogue of a phone conversation. Depending of a permission level, interaction information 212 may be edited by the user, a selected user, and/or other users.

Contacts information 214 is an aggregation of characteristics or quantities that identify a type or category of the user's contacts, such as, social network membership information 215 for those contacts, contact's preference information, contact's frequency of social network characteristics, and the like. Contacts information 214 for a user may be collected from the user, from other users, or from other third party sources, such as, an Internet provider, a phone company, and the like. Information received may be related to social network information, online service information, and telecommunication service information.

In one embodiment, the filtering module 250 ensures that only information the user has legitimate access to for his contacts is received. Social network membership information 215 is information regarding membership to one or more social networks, such as, account types, account names, preferences for accounts, user names, account usage frequency, and the like.

In one embodiment, the server 115 receives from the user a selected list/group of trusted contacts, create a trusted contact profile for each trusted contact, and associate the collection of each trusted contact with the trusted contacts 242. The selected group is individually determined by the user. Each user may generate one list of trusted contacts 242. The user may select, update, and modify the list of trusted contacts 242. The user may base the selection on personal knowledge, perceived knowledge, desired contacts, recommendations, and the like. In one embodiment, the user provides a list of the trusted contacts to the server 115. In another embodiment, the user selects users from a list to be included in the trusted group. Such group is identified further under various denominations such as ‘selected users’, ‘selected group’, ‘selected trusted contacts’, ‘selected contacts’, ‘trusted contacts’ or ‘selected list of trusted contacts’.

A trusted contact profile consists of a personalized profile of a trusted contact a user has selected amongst his list of contacts. Personalized profiles are stored and/or affiliated with the contacts information 214. Contrary to the contacts information 214 that is publicly shared and/or accessible information, the user has exclusive access to the trusted contact profile, may modify, change, and/or create the trusted contact profile. In one embodiment, contacts information 214 is stored online. Information within the trusted contacts 242 may be hidden and/or unattainable by other users if the information is sensitive, based on user preferences, and/or upon request by other users in the trusted network. In one embodiment, the trusted contacts 242 contain information that is dependent on the user's terms. In another embodiment, the trusted contacts 242 contain information that is independent of the contact's terms. By having the personal trusted contacts information 214 independent of the contact's terms but dependent on the user's own terms, there is a richness and authenticity of the information, thereby increasing completeness and accuracy of the information. In one embodiment, accessible personal information is recovered via networking sources in accordance with privacy and/or legal concerns.

A member of a selected group of a user has a higher propensity to obtain more and richer information from the user who selected the group than another user who is not a member of the selected group of the user. For example, if Paul selects John to be in Paul's selected group, then John can obtain more and/or greater detailed information regarding Paul and/or information Paul has supplied.

Activity information 216 is an aggregation of social activities, such as, information regarding trips, vacations, outings, concerts, performances, shows, sporting events, sporting participation, outdoor activities, indoor activities, project information, and any other activity where two or more people participate and/or are spectators. Activity information 216 may be generated by the user, a user in the trusted profile, a non-user and/or retrieved from a network. For example, a user manually enters the activity information 216. In another example, the activity information 216 is extracted by the sorting module 210 from an event planning software, such as evite.com, Microsoft Outlook, and the like. The activity information 216 is collected by the sorting module 210. In one embodiment, activity information 216 is grouped by the activities with unique attributes, such as a name of the event, a time and a place. In one embodiment, the user/supplier of the activity information 216 allocates accessibility to the activity information 216 based on the selected group. In another embodiment, the user allocates accessibility to the activity information 216 based on the social capital 234 of other users.

In one embodiment, a user selects a group of the managed activities 244. The grouping of managed activities 244 may be presented as a list of managed activities 244. The managed activities 244 are a user specified collection of selected events and/or projects, whereby some information of the events and/or projects is within the activity information 216. The managed activities 244 may be modified, updated, and/or deleted by the user. By managing activities of the managed activities 244, the user may focus on recommendations, computations and manipulations to that may be important to the user. In another embodiment, the user identifies specific information and/or activities that are important to the user, of which the server 115 uses to refine the social indicators 232 and/or the social capital 234. For example, if a user identifies an activity or an attribute of an activity that has an affinity variable for a trusted profile, or an importance/worth variable for a managed activity, the server 115 adjusts the social indicators 232 to reflect the importance of the activity and/or the attribute of the activity.

In one embodiment, the activities and associations of the managed activities 244 are private to the user, whereas the information of the activity information 216 is public.

In one embodiment, project information is a subset of activity information 216 and may include any activity information 216 wherein the activity has a value for exchange between the parties, and/or a third party benefit. Some examples of a third party benefits are fund raisers, volunteer work, and some speaking events. In one embodiment, project information may be shared and/or extended to more users/people than the users/people within the network of trust, thereby having a lower threshold to obtain the information.

The analytics module 220 consumes the information associated by the sorting module 210 with interaction information 212, contacts information 214 and activity information 216, and gathers statistics and trends that encourage participation, such as reciprocity of interactions, an evolution of a user's network, an evolution of the social capital of a user, and the like. The reciprocity of interactions is based on how frequently a user interacts with the user's network as opposed to how frequently the network interacts with the user.

The analytics module 220 may display series, graphs and charts by using the data it has collected. For example, it can display a chart with the activities of the user on his various social networking sources

The social capital module 230 computes a series of social indicators 232 using the information that has been provided by the user, and information that has been provided about the user by other users in their trusted contacts 242. The trusted contacts mechanism which allows users to provide information about other users on their own terms helps to ensure that the information gathered is significant and reliable, which allows a better accuracy in the computation of the social capital 234 and social indicators 232. Other indicators may include a number of connections, achievements, affinities, and any relevant additional data. In one embodiment, the social capital 234 is computed as a combination of such social indicators 232.

### Social Indicators

The social indicators 232 comprise one or more indicators related to a bonding indicator 236, a bridging indicator 237, and an achievements indicator 238. The bonding indicator 236, (a closeness of the user to his contacts) may include a trust indicator, an affinities indicator, and/or a knowledge indicator. The bridging indicator 237, (a potential to reach new contacts across the network), may include a connections indicator, and/or a reputation indicator. The achievements indicator 238 is a metric of an influence a user has within a social network to accomplish a task and/or activity. The achievements indicator 238 may be considered a potential to get things done via a social network. Some attributes of the achievements indicator 238 are networking skills, implementation skills, knowledge of the activities, management skills, and any other skills that may be used to perform the desired activity.

In one embodiment, the trust indicator is determined based on the user's selected contacts group and/or on and the other users' selected contacts group. For example if a user has been included in another user's selected contacts group, that user's trust indicator is increased. If both users are in each other's selected contacts group, the trust indicator is increased more than if just one user is in the other's selected contacts group. In one embodiment, the trust indicator is determined based on the feedback other users may provide anonymously about the user. In another embodiment, the trust indicator is determined based on a depth and accuracy of knowledge the user has regarding others and/or a depth and accuracy of knowledge others have regarding the user. In another embodiment, the trust indicator is determined based on information coming from the user's activity, inside the server 115 or externally in other social network sources, such as whether the requests the user is making to access information or to connect to other users are accepted or not.

The affinities indicator is determined by analyzing a user's aggregated interactions, such as e-mail, phone calls, online communications, the user's affiliation and/or affinity with the other users, and/or a reciprocity of the relationship between the others users and the user. Reciprocity may be measured by how often the other users initiate contact with the user, how the other users know the user, and the other users affiliation and/or affinity with the user. Affinity can also be manually specified for a user that is part of a selected group of trusted contacts.

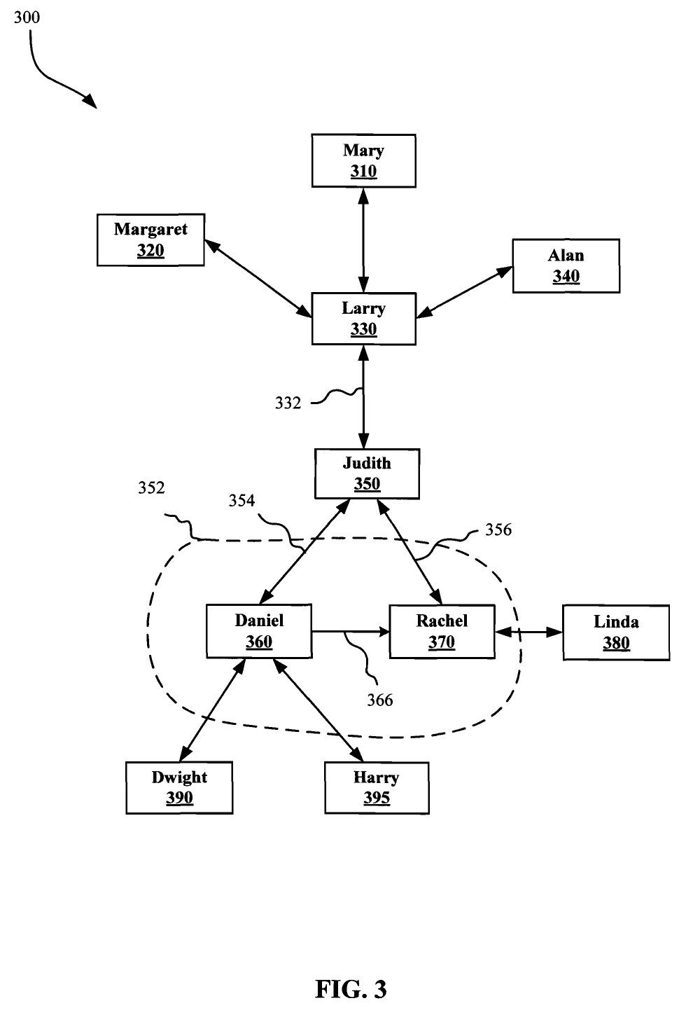

The knowledge indicator is determined by a user's degree of knowledge of other users that are part of his selected group of trusted contacts, such as information provided about the other users or provided by the user himself and matching to what other users says about the subject of the information. Indicators related to bonding are further discussed with respect to FIG. 3 and herein.

The connections indicator is determined based on the extent of affiliations of the selected contacts group of the user and an extent of participation of groups and communications participated by the user. The extent of affiliations of the selected contacts group is determined based on social activity diversity, that is, a social affiliation of each member of the selected group. The social affiliation of each member is based on each member's volume of communications, depth of communications, and/or a variety of affiliation with associated groups and communities. For example, if a user who has a selected group wherein the members of the selected have high affiliations with several groups, and an important depth of extended relations, then the user may have a high connections indicator.

The reputation indicator is determined based on how the user's social presence, online of in real life, is perceived by other users, how well maintained are his public profiles and information, how many referrals does the user gets, and the like. For example, if a user have a public profile on Facebook and have public information on there that might be inappropriate or should be protected, then his reputation indicator might be lowered. Determining such adequacy of public information or breach of privacy can be manual, through anonymous input of other users that are connected to the user, or semi-automatic, by analyzing the content of the public information and detecting patterns the users has identified as private. In another example, if a user is usually helping others and participating fully in his selected contacts group activities, his reputation can be increased.

The influence indicator is determined based on the attraction the user generates within his network. This includes factors such as the number of requests the user receives in his social networking accounts, or the density of the replies he get for his public posts or comments. For example, if the user receives a lot of request to connect on his Twitter or MySpace account, his influence indicator will increase. If the user has people regularly participating in a relatively large number of activities hosted by the user, the influence factor of the user may increase. If on the other hand the user has a high number of posts or comments on his Facebook account that receive no replies, an influence factor of the user may decrease. Indicators related to bridging are further discussed with respect to FIG. 3 and herein

The achievements indicator 238 is determined based on available information about the user's realizations, such as his resume, qualifications, awards, successful projects, such as fundraisers, community organizing, volunteering, and the like. For example, if a user has his profile on a professional social networking site such as LinkedIn, that information can be parsed to obtain his experience and qualifications that will increase his achievements indicators. In another example, if the user has a profile on a web site like fundables.com where the user has successfully participated in a fundraising, the achievements indicator 238 of the user may rise.

The social capital module 230 computes the social capital 234 based on the social statistics 222, the social indicators 232, managed activities 244, and/or the trusted contacts 242. After an initial social capital is determined, the social capital module 230 makes adjustments to the social capital 234 based on social activities and interactions of the user. Some adjustments may be to increase or decrease the social capital 234.

In one embodiment, the social capital module 230 queries organizations, communities, and/or groups to determine an accuracy and/or correctness of user provided affiliations and participation. The querying may be manual or automatic. The querying provides a check for user entries.

The social assistance module 240 searches and provides suggestions to users. The social assistance module 240 accesses interaction information 212, contacts information 214, activity information 216, social indicators 232, social capital 234, trusted contacts 242, and/or managed activities 244. The social assistance module 240 may search information in other user's selected trusted contacts profiles to obtain people to contact and/or associate, events to attend, and frequencies of interactions, and provides suggestions regarding the findings to the user. The trusted contact profiles mechanism that allows a user to provide information about a contact on his own terms help ensure a richness and an accuracy of the information that the social assistance module 240 is going to use. The social assistance module 240 may also take actions such as sending gift to a contact, replying automatically to an event, post information in a web site. Suggestions and actions done by the social assistance module 240 may be used by the user to improve, to build, and/or to maintain social indicators 232, and therefore social capital 234. In one embodiment, the social assistance module 240 receives a request from the user to perform a search. In another embodiment, the user provides a goal to the suggestion module 260, and the suggestion module 260 periodically provides suggestions to the user in order to meet the user's goal.

As more and richer information provided by users is received by the server 115 and allocated to the trusted contacts 242 and/or the managed activities 244, the social assistance module 240 may provide a greater depth and accuracy to the information collected for the people who desire to use the information. In one embodiment, the social assistance module 240 bases suggestions on a user's affinity of others. In another embodiment, the social assistance module 240 implements anti-spam rules, and addresses abuses, violations, and any kind of misguided intrusions, such as illicit, illegal or fake information, in the network of trust. The social assistance module 240 may identify such breaches, tag the breach, and implement corrective action, such as warnings to the user, filtering and/or suspending input from the breaching user, and/or report the user to an administrator.

In one embodiment, a user may review calculations made by the server 115, and the user may manually adjust social affiliations that the server 115 may have miscalculated, omitted, and/or incorrectly associated.

In another embodiment, a user may request feedback from other users on how to improve social capital 234, or any of the social indicators 232. The feedback may be requested from the members of the selected contacts group, members of affiliations, and/or members at large. The feedback may be submitted anonymously.

The filtering module 250 filters user requests. A user request may be a request for information about trusted contacts 242, or a request for information about managed activities 244. The filtering module 250 may execute the request based on certain criteria. Some criteria are based on an association of the user requesting the information to the information, the information being requested, an affinity of the user requesting the information with the user of whom the requested information is associated to, an attribute of the information, and/or the like. For example, if an event has been identified to be shared with everyone, no filtering of the managed activities 244 is performed. In another example, if information in trusted contacts 242 is requested by a user with a social capital which is lower than a specified level, some or no information may be relayed.

In one embodiment, the filtering module 250 determines if a user is a member of the selected group. In another embodiment, the filtering module 250 determines if a user requesting information has access to the information based on being a member of the selected group. For example, if Paul is a member of John's selected group, then the filtering module 250 determines that Paul is privy to John's information.

In another embodiment, the filtering module 250 filters users based on past requests, associations with the owner of the information, and/or associations with the information. In an example based on past requests, if Paul has previously requested information from Mark, and Mark has repeatedly permitted the access, then the filtering module 250 may permit Paul to access more of Mark's information without Mark's affirmation. In an example of association with the owner, if Paul and Mark have had several interactions, and these interactions are stored in the interaction information 212, the filtering module 250 may allow Paul to access Mark's information. In an example of an association with the information, if Paul requests information on a particular event, and Paul has a high affiliation to the event, the filtering module 250 may allow Paul to access the information. A high affiliation may be based on a high social capital, a quantity and/or quality of interactions with the event/information, and the like.

In some embodiments, the filtering module 250 filters requests based on prior associations. For example, if Mark has not have associated with Sid for the past several month, then the filtering module 250 denies Mark access to Sid's information. In another example, if Frank has associated with Sid several times in the past month, then the filtering module 250 allows Frank access to Sid's information. In one embodiment, prior associations are based on frequency. In another embodiment, prior associations are based on time. In another embodiment, prior associations are based on frequency and time.

FIG. 3 illustrates a community 300 of users with social capital at a user level, in accordance with embodiments. The community 300 comprises users, such as users Mary 310, Margaret 320, Larry 330, Alan 340, Judith 350, Daniel 360, Rachel 370, Linda 380, Dwight 390, and Harry 395, and a selected group 352. Names depicted in FIG. 3 are for example only and may vary in different embodiments.

### Social Capital

A value of social capital may be explained by example. In one example of the value of social capital, the following occurs:

### Judith

Judith 350 likes to socialize with her network of friends, family and peers, and regularly communicate via social networking sites, e-mails, phone, and the like. Also, Judith 350 makes an effort to participate in her community by volunteering for charitable associations.

Recently Judith 350 has been wondering about such things as how well she was doing with respect to her social life, that is, what are the impacts (positive or not) of her activities online, is she a good friend, a colleague and/or sister, should she keep investing that much in her community, and should she be doing more or less of her activities. To alley any concerns and make informed decisions Judith 350 can consult her social capital. Judith 350 supplies social and other information, such as, social networking accounts, email accounts, phone numbers, and volunteer work in order to determine her social capital.

The server 115 then computes a range of social indicators 232 for Judith 350. From those indicators, the server 115 also determines the social capital 234 for Judith 350. Judith 350 receives from the server 115 an acceptable affinity indicator, whereby Judith interprets this to mean that she is keeping regularly in touch with her contacts and she's liked, which is important for her. Her trust indicator however, is low, and she doesn't like it. She requests the assistance of the social assistance module 240 to help her improve that score. The social assistance module 240 determines that Judith 350 has not selected enough trusted contacts in her list of trusted contacts, and therefore, hasn't identified enough trusted people to increase her trust score. Moreover, there are only few users that have added her in their network of personal trust either, and it might be due to the fact that most of her friends and close relations are not part of the community 100 with for social capital. The social assistance module 240 explains its findings to Judith 350. Upon reviewing the suggestion she's been given, Judith 350 decides to add trusted contacts to her selected list of trusted contacts, and to invite them to use the community 100.

### Daniel

Daniel 360 is a close friend of Judith 350, as indicated by connection 354, and considers himself to be a social person. Daniel 360 likes to meet new people and expand his network. Daniel 360 is aware that the connections he is making have value. Daniel 360 would like to be able to reach more interesting people, but cannot afford to waste too much time figuring out whom to contact, which events to attend, what venues to choose, and the like.

On a relative scale, Daniel 360 learns that he has high values for indicators related to bridging but a low values for indicators related to bonding. As he's interested in expanding his network, Daniel 360 request assistance to improve his indicators related to bridging. The social assistance module 240 analyses the events, from the list of events he has selected or from the public list of events that the module can discover in his social sources and that are the most profitable for Daniel 360 bridging indicators. The social assistance module 240 finds an event with attendees that are good networking potential for Daniel 360 and transmit the information and the suggestion to Daniel 360 who does not have to waste time figuring that himself. Although Daniel 360 was interested only in improving his bridging related indicator, the feedback will reveal to him that improving his indicators related to bonding is important as well, because a high bonding also relates to a productiveness of his contacts.

### Rachel

Rachel 370 works with Daniel 360. Daniel 360 has added her in his selected group of trusted contacts, as indicated by connection 366, and he has sent her an invitation to join. Connection 366 is indicated by a single arrow head indicating that a first user is in the second user's selected group and that the second user is not in the first user's selected group. Although Rachel 370 appreciates Daniel 360 and is thankful that he added her in his selected group, Rachel 370 would not like to share trusted information with him, so she decides not to add him in her selected group. Thus, Rachel 370 has a higher propensity to see information provided by Daniel 360, than Daniel 360 has to see information provided by Rachel 370. In one embodiment, a decision to accept an invitation to a selected group is transparent to an inviter. Thus, after Daniel 360 has included Rachel 370 in his selected group, and sent an invitation for Rachel 370 to include Daniel 360 in her selected group, Daniel 360 may not be able to determine whether or not Rachel 370 has included him in her selected group. In another embodiment, reciprocity of adding two or more users to respective selected groups is indicated by a message from the server 115.

Rachel 370 also knows Judith 350, as indicated by connection 356, believes Judith 350 is empathetic, would like to better know her, and is interested in being closer to her. So Rachel 370 adds Judith 350 to her selected group, thereby Judith 350 and Rachel 370 are in each other's selected group.

A user, such as Rachel 370, may review information provided by other users who have selected the user to be a part of the selected group of the other users. Thus, Rachel 370 may access a personal profile of Judith 350, which contains information provided by Judith 350 and may access information provided by Judith 350 of others, such as, information regarding Larry 330 provided by Judith 350.

In one embodiment, completeness and an accuracy of the information desired and obtained through another user is dependent on the affinity between the user and another user. For example, if Judith 350 has authorized personal notes to be shared with members of her selected group, and Judith 350 has set an affinity criteria, Rachel 370 may be able to view the personal notes if she has meet both criteria. In another embodiment, a user may individually select which users may obtain certain information. For example, Judith 350 may choose to keep the entire information private from Rachel 370 or select a portion of information to share with others, such as Rachel 370.

Users may add information regarding other users. For example, Rachel 370 may add her own set of information regarding Judith 350 and in her own terms, knowing that it will enable other users that know Judith 350 to access the information.

### Unavailability Mode

In one embodiment, the server 115 considers a user who is inactive due to being absent, on vacation, sick, leave, and the like. A user may indicate a leave of absence, so as the absence will not be construed negatively with respect to social statistics 222. For example, if a user is taking a sabbatical for a year, and is not available to provide input/activity, the server 115 will not penalize the user for the inactivity and lack of communications with other users, friends, peers, etc. The server 115 may suspend communications to the user until the user returns, thus avoided a flood of untimely event communications.

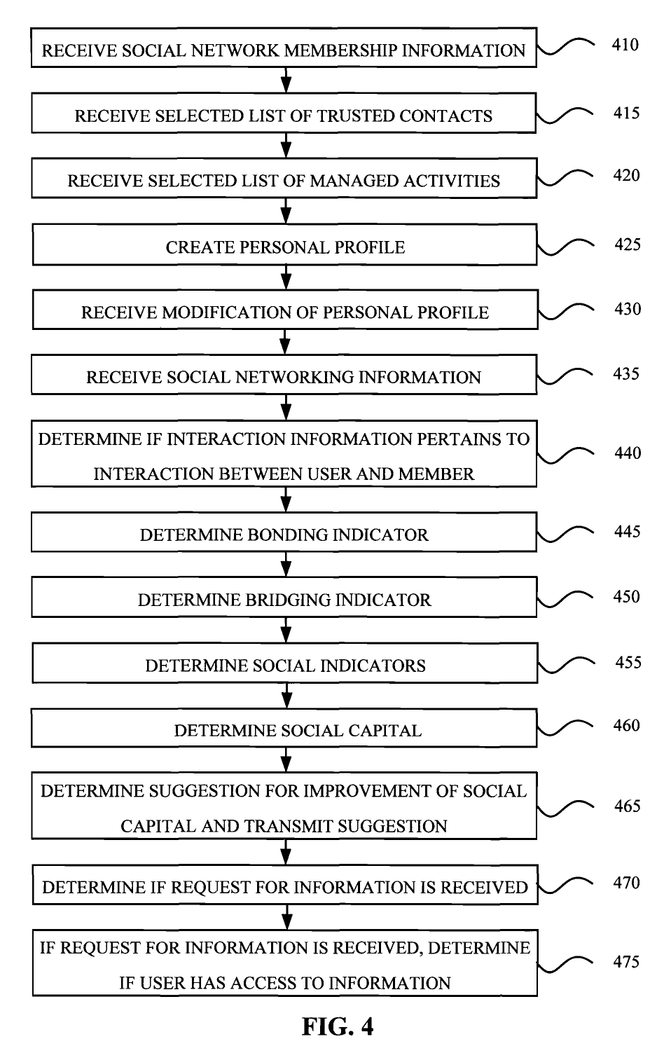

FIG. 4 is a flow chart of a method for social capital implementation, in accordance with embodiments. In step 410, the server 115 receives social network membership information from a user.

In various embodiments, in step 415 the server 115 receives a selected list of trusted contacts. The selected list of trusted contacts may be a list of friends, and/or a list of trusted individuals. The selected list of trusted contacts may be independent of members and/or users of the server 115.

In various embodiments, in step 420, the server 115 receives a selected list of managed activities. In one embodiment, the server receives the selected list of trusted contacts and the selected list of managed activities together.

In various embodiments, in step 425 the server 115 creates a personal profile for each trusted contact in the selected list of trusted contacts and/or for each activity in the selected list of managed activities.

In various embodiments, in step 430 the server 115 receives modifications of the personal profiles and/or of the managed activities 244 by the user.

In step 435, the server 115 receives social networking information 211, such as, interaction information 212, contacts information 214, and/or activity information 216 for the user and from various sources. Various sources of information are detailed herein.

In various embodiments, in step 440 the server 115 determines if any interaction information 212 pertains to interactions between the user and a member of the selected list of trusted contacts. In one embodiment, the interaction information 212 is received by the user as the user provides social networking information 211. In another embodiment, the interaction information 212 is obtained from submissions by others, such as the member of the selected list of trusted contacts and/or other users.

In step 445, the server 115 determines a bonding indicator 236. In various embodiments, the bonding indicator 236 is updated after an initial social capital is determined. The bonding indicator 236 is further discussed herein.

In step 450, the server 115 determines a bridging indicator 237. In various embodiments, the bridging indicator 237 is updated after an initial social capital is determined. The bridging indicator 237 is further discussed herein.

In various embodiments, in step 455, the server 115 determines the social indicators, as discussed herein.

In step 460, the server 115 determines the social capital 234. In various embodiments the social capital 234 is determined using the social network membership information 215 from the user and the social networking information 211 from the user and other sources. In other embodiments, the social capital 234 is determined based on the using the social network membership information 215 solely from the user. In one embodiment, the social capital is determined at least partially based on the bonding indicator 236. In another embodiment, the social capital is determined at least partially based on the bridging indicator 237. In another embodiment, the social capital is determined at least partially based on the interactions, activity, the achievements indicator 238, and/or other social networking information of the user.

In various embodiments, in step 465, the server 115 and/or the social assistance module 240 determines a suggestion for improving the social capital 234 and transmits the suggestion to the user. The user may accept or decline the suggestion. In one embodiment, if a suggestion is accepted, corresponds to an action that may be performed by the server 115, then the server 115 executes the actions, thus improving the social capital of the user with little to no input by the user. Some self executing server 115 actions include publishing a blog post on a web site, sending a gift to a friend, connecting with a relation via Skype, replying to a message with a template answer, and the like. In one embodiment, the suggestion for improvement of the social capital is at least partially based on the selected list of trusted contacts. In another embodiment, the suggestion for improvement of the social capital is at least partially based on the selected list of managed activities.

In various embodiments, the server 115 determines potential improvements to the social capital of a user based on knowledge in the selected list of trusted contacts, the selected list of managed activities, the social capital, the social indicators, the activity information 216 and interaction information 212 of the user, the preferences and the settings of the user. In one embodiment, the server 115 learns and adapts to a social environment of the user to target only certain improvements that are susceptible to be accepted by the user.

In various embodiments, in step 470, the server 115 determines if a request for information of a member is received. In various embodiments, the server 115 determines if the information is owned by a member who has identified the user as being part of the list of trusted contracts. In step 475, if the request for information is received, then the server 115 determines if the user has access to the information owned by the member. In various embodiments, the server 115 will permit access by the user of the information owned by the member if the member has identified the user as a member on the selected list of trusted contacts, as discussed herein.

Various alternatives, modifications, and equivalents may also be used. In various embodiments, the steps of receiving information networking information 211, information regarding the list of trusted contacts 242, the list of managed activities 244 may vary in different embodiments. For example, the server 115 may initially receive some of the list of trusted contacts 242 and some social networking information 211, and later receive more social networking information 211, more of the list of trusted contacts 242, and the list of managed activities 244, and even later receive modifications and/or updates of information and lists.

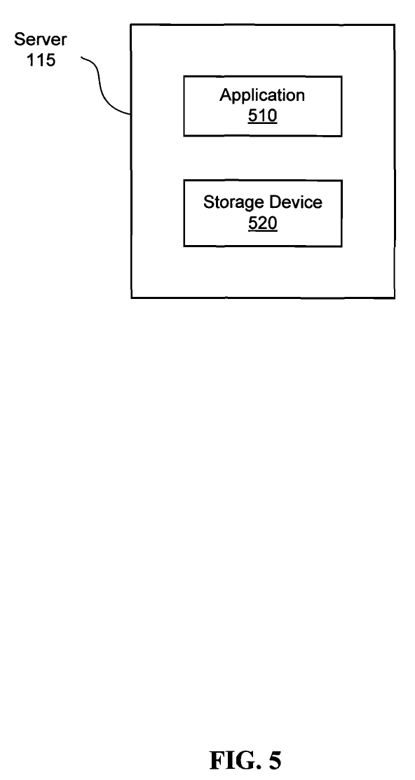

FIG. 5 illustrates a server 115, in accordance with embodiments. As illustrated, the server 115 comprises an application 510, and a storage device 520. The application 510 is configured to run on the server, and configured to receive social network membership information 215 from a user, to receive activity information 216, and to use the social network membership information 215 and the activity information 216 to determine the social capital 234 for the user. The storage device 520 is configured to store information, such as the social capital 234, social indicators 232, interaction information 212, contacts information 214, activity information 216, selected list of trusted contacts 242, managed activities 244, and any other information used for a determination of the social metrics.

In various embodiments, the server 115 contains a computer readable medium having embodied thereon a program, the program being executable by a computing device for performing a method for social capital determination and use. The program is configured to receive social network membership information 215 from a user; to receive activity information 216 for the user, to receive a selected list of trusted contacts, and to use the social network membership information 215, the activity information 216, and the selected list of trusted contacts, to determine the social capital 234 for the user.

Various alternatives, modifications, and equivalents may also be used. For example, the steps of determining a social capital may vary depending on when social statistics 222 are received, altered and/or omitted. In another example, the social capital may be determined by weighting certain metrics, such as the indicators of the social indicators, more than other social metrics for different users. Therefore, the above description should not be taken as limiting the scope of the invention which is defined by the appended claims.

While the invention is described in conjunction with various embodiments, it is understood that they are not intended to limit the invention to these embodiments. On the contrary, the invention is intended to cover alternatives, modifications and equivalents, which may be included within the spirit and scope of the invention as defined by the appended claims.

What is claimed is:

1. A method comprising:
receiving social network membership information from a user;
receiving social networking information for the user; and
determining a social capital for the user, wherein the social capital is at least partially based on the social network membership information, and the social networking information.

2. The method of claim 1, wherein the social network membership information is membership information selected from a group consisting of third party social network information, online service information, and telecommunication service information.

3. The method of claim 1, wherein the determination of the social capital is at least partially based on a bonding indicator, a bridging indicator, and/or an achievements indicator.

4. The method of claim 3 wherein the bonding indicator is at least partially based on information about interactions of the user.

5. The method of claim 3, wherein the bridging indicator is at least partially based on information about social activities of the user.

6. The method of claim 3, further comprising receiving an achievement information from a third party source; and determining at least one achievements indicator, wherein the at least one achievements indicator is at least partially based on the achievement information.

7. The method of claim 1, further comprising receiving a selected list of trusted contacts.

8. The method of claim 7, further comprising creating a personal profile for each trusted contact in the selected list of trusted contacts.

9. The method of claim 8, further comprising receiving modifications of the personal profiles by the user.

10. The method of claim 8, wherein the personal profiles access is protected from unauthorized access.

11. The method of claim 7, further comprising receiving interaction information; and
determining if the interaction information pertains to interactions between the user and a member of the selected list of trusted contacts.

12. The method of claim 11, further comprising updating a bonding indicator, wherein the bonding indicator is at least partially based on the interaction information.

13. The method of claim 1, further comprising receiving a selected list of managed activities.

14. The method of claim 13, further comprising updating a bridging indicator, wherein the bridging indicator is at least partially based on the social networking information and the selected list of managed activities.

15. The method of claim 1, further comprising determining a suggestion for an improvement for the social capital of the user, and transmitting the suggestion to the user.

16. The method of claim 15, further comprising receiving a selected list of trusted contacts, wherein the determination of the suggestion is at least partly based on the selected list of trusted contacts.

17. The method of claim 15, further comprising receiving a selected list of managed activities, wherein the determination of the suggestion is at least partly based on the selected list of managed activities.

18. A method comprising:
receiving social network membership information from a user;
receiving social networking information for the user;
receiving a selected list of trusted contacts; and
determining a social capital for the user, wherein the social capital is at least partially based on the social network membership information, the social networking information, and the selected list of trusted contacts.

19. The method of claim 18, wherein the determination of the social capital is at least partially based on a bonding indicator, a bridging indicator, and/or an achievements indicator.

20. A computer readable medium having embodied thereon a program, the program being executable by a computing device for performing a method for social capital determination comprising:
receiving social network membership information from a user;
receiving social networking information for the user;
receiving a selected list of trusted contacts; and
determining a social capital for the user, wherein the social capital is at least partially based on the social network membership information, the social networking information, and the selected list of trusted contacts.
